(19) United States
(12) Patent Application Publication
(10) Pub. No.: US 2026/0236365 A1
(43) Pub. Date: Aug. 13, 2026

(54) PROACTIVE MANAGEMENT OF PORTS OF AN INFORMATION HANDLING SYSTEM

(71) Applicant: Dell Products L.P., Round Rock, TX (US)

(72) Inventors: Laxmi Lavanya Medicherla, Georgetown, TX (US); Ibrahim Sayyed, Georgetown, TX (US); Alan Helmy Abdelhalim, Pflugerville, TX (US)

(21) Appl. No.: 19/051,354

(22) Filed: Feb. 12, 2025

(51) Int. Cl. G06F 11/30

(52) U.S. Cl. CPC G06F 11/3041; G06F 11/3062

(57) ABSTRACT

Proactive management of ports of an information handling system, including determining whether a port of the information handling system is engaged with an external computing device; in response to determining that the port is engaged with the external computing device: obtaining telemetry data values of one or more characteristics associated with the port; analyzing the telemetry data values, including, for one or more of the characteristics: comparing the telemetry data value for the particular characteristic to telemetry data value operating range associated with the particular characteristic; determining, based on the comparing, whether the telemetry data value for the particular characteristic is outside of the telemetry data value operating range associated with the particular characteristic; in response to determining that the telemetry data value for the particular characteristic is outside of the telemetry data value operating range associated with the particular characteristic, adjusting one or more parameters associated with the port.

### BACKGROUND

### Field of the Disclosure

The disclosure relates generally to an information handling system, and in particular, proactive management of ports of the information handling system.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Telemetry data collection involves gathering real-time data from remote or inaccessible sources for monitoring and analysis. This data is used for understanding system performance, detecting anomalies, and making informed decisions. Various industries, including telecommunications, healthcare, and automotive, rely on telemetry to ensure their systems and devices operate efficiently and effectively.

### SUMMARY

Innovative aspects of the subject matter described in this specification may be embodied in a method of proactive management of ports of an information handling system, including determining whether a port of the information handling system is engaged with an external computing device; in response to determining that the port is engaged with the external computing device: obtaining telemetry data values of one or more characteristics associated with the port; analyzing the telemetry data values, including, for one or more of the characteristics: comparing the telemetry data value for the particular characteristic to a telemetry data value operating range associated with the particular characteristic; determining, based on the comparing, whether the telemetry data value for the particular characteristic is outside of the telemetry data value operating range associated with the particular characteristic; and in response to determining that the telemetry data value for the particular characteristic is outside of the telemetry data value operating range associated with the particular characteristic, adjusting one or more parameters associated with the port.

Other embodiments of these aspects include corresponding systems, apparatus, and computer programs, configured to perform the actions of the methods, encoded on computer storage devices.

These and other embodiments may each optionally include one or more of the following features. For instance, storing the telemetry data values at a data store. Determining that the port is engaged with the external computing device further includes determining that the external computing device is receiving power through the port. Adjusting the one or more parameters associated with the port includes adjusting a time interval for obtaining the telemetry data values of the one or more characteristics associated with the port. Adjusting the one or more parameters associated with the port includes obtaining telemetry data values of one or more differing characteristics associated with the port. In response to determining that the port is not engaged with the external computing device, putting the port in a dormant state such that obtaining the telemetry data values is halted for a time period. The port is a Universal Serial Bus (USB) Type-C port. The external computing device is a power adapter.

Particular implementations of the subject matter described in this specification can be implemented so as to realize one or more of the following advantages. For example, improved port usage monitoring, timely diagnostics, and comprehensive instrumentation; provide actionable insights, reduce downtime, and enhance overall system performance through continuous and adaptive telemetry strategies; and reduced system down time, service call volume reduction by closely monitoring and diagnosing particular port usage scenarios, and avoidance of unnecessary dispatches.

The details of one or more embodiments of the subject matter described in this specification are set forth in the accompanying drawings and the description below. Other potential features, aspects, and advantages of the subject matter will become apparent from the description, the drawings, and the claims.

### BRIEF DESCRIPTION OF DRAWINGS

FIG. 1 is a block diagram of selected elements of an embodiment of an information handling system.

FIG. 2 illustrates a block diagram of an information handling system for proactive management of ports.

FIG. 3 illustrates a method for proactive management of ports of the information handling system.

### DESCRIPTION OF PARTICULAR EMBODIMENT(S)

This disclosure discusses methods and systems for proactive management of ports of an information handling system. In short, there is a need for real-time data and analysis for continuous, context-aware telemetry at the port for comprehensive monitoring, timely diagnostics and efficient resource use at the port. Proactive and adaptive telemetry can be provided based on port engagement for improved port usage monitoring, timely diagnostics and comprehensive instrumentation. That is, the ability to detect when the port is connected/disconnected and perform telemetry data collection based on such connection; and proactive and adaptive port usage context aware telemetry collection and analysis for system wide efficiency and preventative health maintenance.

Specifically, this disclosure discusses a system and a method for proactive management of ports of an information handling system, including determining whether a port of the information handling system is engaged with an external computing device; in response to determining that the port is engaged with the external computing device: obtaining telemetry data values of one or more characteristics associated with the port; analyzing the telemetry data values, including, for one or more of the characteristics: comparing the telemetry data value for the particular characteristic to a telemetry data value operating range associated with the particular characteristic; determining, based on the comparing, whether the telemetry data value for the particular characteristic is outside of the telemetry data value operating range associated with the particular characteristic; and in response to determining that the telemetry data value for the particular characteristic is outside of the telemetry data value operating range associated with the particular characteristic, adjusting one or more parameters associated with the port.

In the following description, details are set forth by way of example to facilitate discussion of the disclosed subject matter. It should be apparent to a person of ordinary skill in the field, however, that the disclosed embodiments are exemplary and not exhaustive of all possible embodiments.

For the purposes of this disclosure, an information handling system may include an instrumentality or aggregate of instrumentalities operable to compute, classify, process, transmit, receive, retrieve, originate, switch, store, display, manifest, detect, record, reproduce, handle, or utilize various forms of information, intelligence, or data for business, scientific, control, entertainment, or other purposes. For example, an information handling system may be a personal computer, a PDA, a consumer electronic device, a network storage device, or another suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include an instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory (SSD); as well as communications media such as wires, optical fibers, microwaves, radio waves, and other electromagnetic and/or optical carriers; and/or any combination of the foregoing.

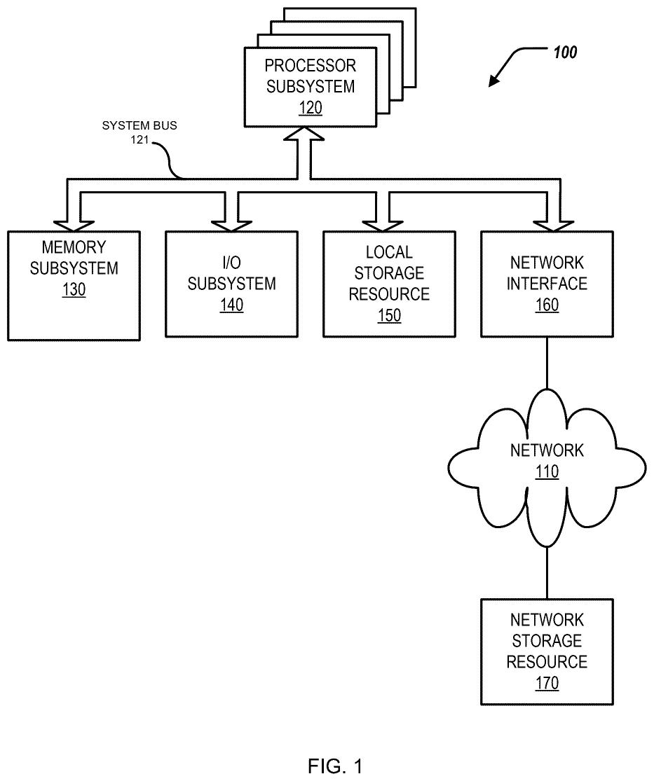

Particular embodiments are best understood by reference to FIGS. 1-3 wherein like numbers are used to indicate like and corresponding parts.

Turning now to the drawings, FIG. 1 illustrates a block diagram depicting selected elements of an information handling system 100 in accordance with some embodiments of the present disclosure. In various embodiments, information handling system 100 may represent different types of portable information handling systems, such as, display devices, head mounted displays, head mount display systems, smart phones, tablet computers, notebook computers, media players, digital cameras, 2-in-1 tablet-laptop combination computers, and wireless organizers, or other types of portable information handling systems. In one or more embodiments, information handling system 100 may also represent other types of information handling systems, including desktop computers, server systems, controllers, and microcontroller units, among other types of information handling systems. Components of information handling system 100 may include, but are not limited to, a processor subsystem 120, which may comprise one or more processors, and system bus 121 that communicatively couples various system components to processor subsystem 120 including, for example, a memory subsystem 130, an I/O subsystem 140, a local storage resource 150, and a network interface 160. System bus 121 may represent a variety of suitable types of bus structures, e.g., a memory bus, a peripheral bus, or a local bus using various bus architectures in selected embodiments. For example, such architectures may include, but are not limited to, Micro Channel Architecture (MCA) bus, Industry Standard Architecture (ISA) bus, Enhanced ISA (EISA) bus, Peripheral Component Interconnect (PCI) bus, PCI-Express bus, HyperTransport (HT) bus, and Video Electronics Standards Association (VESA) local bus.

As depicted in FIG. 1, processor subsystem 120 may comprise a system, device, or apparatus operable to interpret and/or execute program instructions and/or process data, and may include one or more processing resources such as a central processing unit (CPU), microprocessor, microcontroller, digital signal processor (DSP), application specific integrated circuit (ASIC), or another digital or analog circuitry configured to interpret and/or execute program instructions and/or process data. In some embodiments, processor subsystem 120 may interpret and/or execute program instructions and/or process data stored locally (e.g., in memory subsystem 130 and/or another component of information handling system 100). In the same or alternative embodiments, processor subsystem 120 may interpret and/or execute program instructions and/or process data stored remotely (e.g., in network storage resource 170).

Also in FIG. 1, memory subsystem 130 may comprise a system, device, or apparatus operable to retain and/or retrieve program instructions and/or data for a period of time (e.g., computer-readable media). Memory subsystem 130 may comprise random access memory (RAM), electrically erasable programmable read-only memory (EEPROM), a PCMCIA card, flash memory, magnetic storage, opto-magnetic storage, and/or a suitable selection and/or array of volatile or non-volatile memory that retains data after power to its associated information handling system, such as system 100, is powered down.

In information handling system 100, I/O subsystem 140 may comprise a system, device, or apparatus generally operable to receive and/or transmit data to/from/within information handling system 100. I/O subsystem 140 may represent, for example, a variety of communication interfaces, graphics interfaces, video interfaces, user input interfaces, and/or peripheral interfaces. In various embodiments, I/O subsystem 140 may be used to support various peripheral devices, such as a touch panel, a display adapter, a keyboard, an accelerometer, a touch pad, a gyroscope, an IR sensor, a microphone, a sensor, a camera, or another type of peripheral device.

Local storage resource 150 may comprise computer-readable media (e.g., hard disk drive, floppy disk drive, CD-ROM, and/or other types of rotating storage media, flash memory, EEPROM, and/or another type of solid state storage media) and may be generally operable to store instructions and/or data. Likewise, the network storage resource may comprise computer-readable media (e.g., hard disk drive, floppy disk drive, CD-ROM, and/or other types of rotating storage media, flash memory, EEPROM, and/or other types of solid state storage media) and may be generally operable to store instructions and/or data.

In FIG. 1, network interface 160 may be a suitable system, apparatus, or device operable to serve as an interface between information handling system 100 and a network 110. Network interface 160 may enable information handling system 100 to communicate over network 110 using a suitable transmission protocol and/or standard, including, but not limited to, transmission protocols and/or standards enumerated below with respect to the discussion of network 110. In some embodiments, network interface 160 may be communicatively coupled via network 110 to a network storage resource 170. Network 110 may be a public network or a private (e.g., corporate) network. The network may be implemented as, or may be a part of, a storage area network (SAN), a personal area network (PAN), a local area network (LAN), a metropolitan area network (MAN), a wide area network (WAN), a wireless local area network (WLAN), a virtual private network (VPN), an intranet, the Internet or another appropriate architecture or system that facilitates the communication of signals, data and/or messages (generally referred to as data). Network interface 160 may enable wired and/or wireless communications (e.g., NFC or Bluetooth) to and/or from information handling system 100.

In particular embodiments, network 110 may include one or more routers for routing data between client information handling systems 100 and server information handling systems 100. A device (e.g., a client information handling system 100 or a server information handling system 100) on network 110 may be addressed by a corresponding network address including, for example, an Internet protocol (IP) address, an Internet name, a Windows Internet name service (WINS) name, a domain name or other system name. In particular embodiments, network 110 may include one or more logical groupings of network devices such as, for example, one or more sites (e.g., customer sites) or subnets. As an example, a corporate network may include potentially thousands of offices or branches, each with its own subnet (or multiple subnets) having many devices. One or more client information handling systems 100 may communicate with one or more server information handling systems 100 via any suitable connection including, for example, a modem connection, a LAN connection including the Ethernet, or a broadband WAN connection including DSL, Cable, Ti, T3, Fiber Optics, Wi-Fi, or a mobile network connection including GSM, GPRS, 3G, or WiMax.

Network 110 may transmit data using a desired storage and/or communication protocol, including, but not limited to, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or another transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 110 and its various components may be implemented using hardware, software, or any combination thereof.

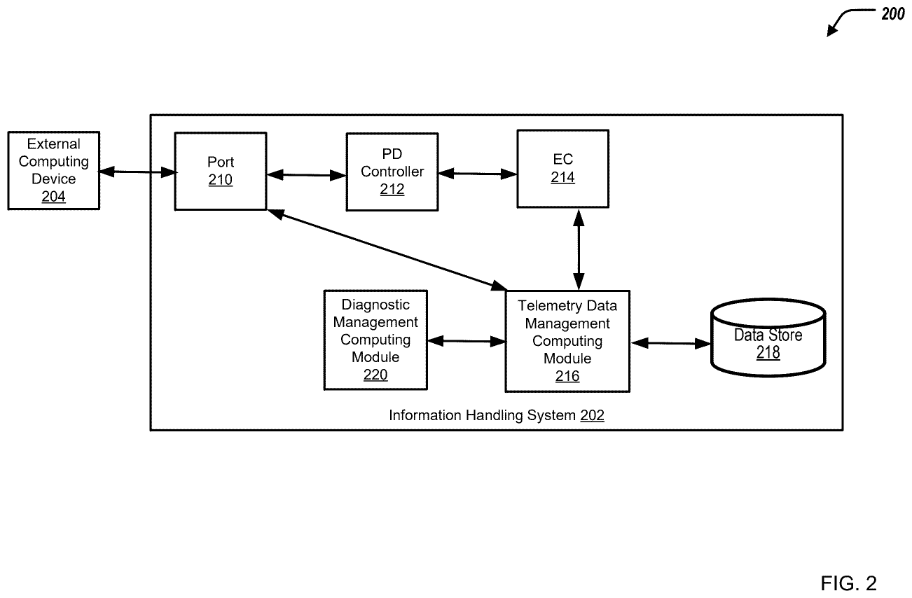

Turning to FIG. 2, FIG. 2 illustrates an environment 200 including an information handling system 202 and an external computing device 204. The information handling system 202 can include a port 210, a power delivery (PD) controller 212, an embedded controller (EC) 214, a telemetry data management computing module 216, a data store 218, and a diagnostic management computing module 220. In some examples, the information handling system 202 is similar to, or includes, the information handling system 100 of FIG. 1.

The port 210 can be in communication with the external computing device 204, the PD controller 212, and the telemetry data management computing module 216. The PD controller 212 can be in communication with the port 210 and the EC 214. The EC 214 can be in communication with the PD controller 212 and the telemetry data management computing module 216. The telemetry data management computing module 216 can be in communication with the port 210, the EC 214, the data store 218, and the diagnostic management computing module 220. The diagnostic management computing module 220 can be in communication with the telemetry data management computing module 216.

In some examples, the port 210 is a Universal Serial Bus (USB) port. In some examples, the port 210 is a USB Type-C port. In some examples, the port 210 is a High-Definition Multimedia Interface (HDMI) port.

In some examples, the external computing device 204 is a power adapter. In some examples, the external computing device 204 includes a power adapter. In some examples, the external computing device 204 include computing elements and a power adapter. In some examples, the external computing device 204 includes a storage device and a power adapter.

In short, there is a need for real-time data and analysis for continuous, context-aware telemetry at the port 210 for comprehensive monitoring, timely diagnostics and efficient resource use at the port 210. Proactive and adaptive telemetry can be provided based on port engagement for improved port usage monitoring, timely diagnostics and comprehensive instrumentation. That is, the ability to detect when the port 210 is connected/disconnected and perform telemetry data collection based on such connection; and proactive and adaptive port usage context aware telemetry collection and analysis for system wide efficiency and preventative health maintenance.

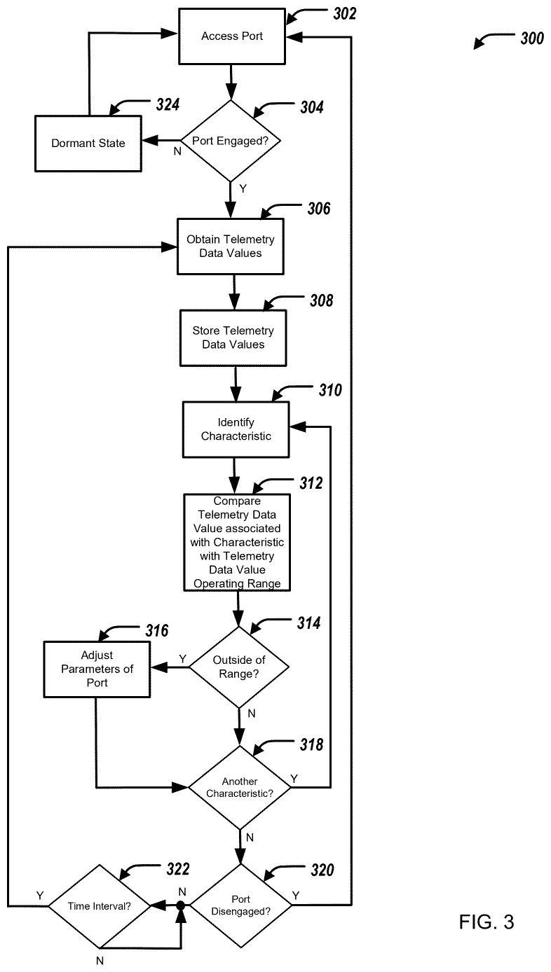

FIG. 3 illustrates a flowchart depicting selected elements of an embodiment of a method 300 for proactive management of ports of an information handling system. The method 300 may be performed by the information handling system 100, the information handling system 202, the PD controller 212, the EC 214, the telemetry data management computing module 216, and/or the diagnostic management computing module 220, and with reference to FIGS. 1-2. It is noted that certain operations described in method 300 may be optional or may be rearranged in different embodiments.

The PD controller 212 accesses the port 210, at 302. That is, the PD controller 212 establishes communication between the PD controller 212 and the port 210. The PD controller 212 and/or the EC 214 can determine whether the port 210 is engaged with the external computing device 204, at 304. In some examples, the PD controller 212 determines whether the port 210 is engaged with the external computing device 204 by determining whether the external computing device 204 is physically engaged with the port 210. In some examples, the PD controller 212 determines whether the port 210 is engaged with the external computing device 204 by determining whether the external computing device 204 is receiving power (from the information handling system 202) through the port 210. In some examples, the PD controller 212 determines whether the port 210 is engaged with the external computing device 204 by determining whether the external computing device 204 is physically engaged with the port 210 and whether the external computing device 204 is receiving power (from the information handling system 202) through the port 210.

The PD controller 212 can provide a communication to the EC 214 indicating the engagement status between the external computing device 204 and the port 210 to the EC 214. That is, upon the external computing device 204 becoming engaged with the port 210, the PD controller 212 can provide a communication to the EC 214 indicating the engagement status between the external computing device 204 and the port 210 to the EC 214. In some implementations, the EC 214 determines the port 210 is engaged with the external computing device 204 (at 304) based on the communication/signal from the PD controller 212.

The telemetry data management computing module 216, in response to the port 210 being engaged with the external computing device 204, obtains telemetry data values of one or more characteristics associated with the port 210, at 306. Specifically, the EC 214 will broadcast a notification to the telemetry data management computing module 216 indicating for the telemetry data management computing module 216 to obtain telemetry data values of characteristics (associated with characteristics) of the port 210. The characteristics of the port 210 can be specific to that port 210 (in that characteristics can vary for each port of the information handling system 202). That is, specific status or features (characteristics) are specific to the port 210. For example, the characteristics of the port 210 (or associated with the port 210) can include connectivity status, power adapter wattage, overshoot current at power delivery (PD) levels, or classification of end points connected to the port 210. For example, the characteristics of the port 210 (or associated with the port 210) can include adapter voltage of the external computing device 204.

The telemetry data management computing module 216 stores the telemetry data values of the characteristics of the port 210 at the data store 218, at 308.

The telemetry data management computing module 216 analyzes the telemetry data values for each of the characteristics. Specifically, the telemetry data management computing module 216 identifies a characteristic of the port 210, at 310. For example, the telemetry data management computing module 216 can identify one of the characteristics of the port 210, including the connectivity status, power adapter wattage, overshoot current at PD levels, classification of end points connected to the port 210, and adapter voltage.

The telemetry data management computing module 216 compares the telemetry data value for the characteristic of the port 210 to a telemetry data value operating range associated with the particular characteristic for the port 210, at 312. Specifically, the telemetry data management computing module 216 can access the data store 218 to identify the telemetry data value operating range for the particular characteristic for the port 210. That is, the data store 218 can store a table indicating, for each type of port, a telemetry data value operating range for each characteristic of the port. For example, when the particular characteristic of the port 210 includes a power adapter wattage of the port 210, the telemetry data management computing module 216 can access the data store 218 to identify a power adapter wattage value range for the port 210.

The telemetry data management computing module 216 determines, based on the comparing, whether the telemetry data value for the particular characteristic is outside of the telemetry data value operating range associated with the particular characteristic, at 314. That is, the telemetry data management computing module 216 determines, based on the comparing, whether the telemetry data value for the particular characteristic is greater than an upper threshold of the telemetry data value operating range associated with the particular characteristic or lower than a lower threshold of the telemetry data value operating range associated with the particular characteristic (the upper threshold and the lower threshold defining the operating range). For example, when the particular characteristic of the port 210 includes a power adapter wattage of the port 210, the telemetry data management computing module 216 can compare the obtained power adapter wattage value of the port with the power adapter wattage value range for the port 210.

In some examples, the telemetry data management computing module 216 can store data at the data store 218 indicating, for the particular characteristic, the deviation of the telemetry data value from the telemetry data value operating range.

In some implementations, the telemetry data management computing module 216 determines that the telemetry data value for the particular characteristic is outside of the telemetry data value operating range associated with the particular characteristic (at 314). In response to determining that the telemetry data value for the particular characteristic is outside of the telemetry data value operating range associated with the particular characteristic, the telemetry data management computing module 216 can provide a communication (or signal) to the diagnostic management computing module 220 to adjust parameters of the port 210, at 316. That is, the telemetry data management computing module 216 can provide a signal to the telemetry data management computing module 216 indicating that the telemetry data value for the particular characteristic is outside of the telemetry data value operating range associated with the particular characteristic. The diagnostic management computing module 220 can identify one or more parameters associated with the port 210 to be adjusted. That is, the diagnostic management computing module 220 can perform diagnostics on the port 210 based on the data value for the particular characteristic, and based on such diagnostics, identify parameters associated with the port 210 to be adjusted. The diagnostic management computing module 220 can provide a signal/communication to the telemetry data management computing module 216 indicating the parameters associated with the port 210 to be adjusted. The telemetry data management computing module 216 can then adjust the parameters associated with the port 210 based on the received signal/communication from the diagnostic management computing module 220.

For example, the diagnostic management computing module 220 determines the adjustments to the parameters associated with the port 210 such that the performance of the port 210 is optimized (such as optimizing power delivery, processing capability, data transfer rate, and the like).

In some examples, the telemetry data management computing module 216 adjusts the parameters associated with the port 210 including adjusting a time interval for obtaining the telemetry data values of the characteristics associated with the port 210. That is, the telemetry data management computing module 216 can adjust dynamically how the telemetry data values are obtained—e.g., every 5 minutes, 10 minutes, 15 minutes. That is, once the external computing device 204 is engaged with the port 210 and the initial telemetry data values are obtained, the telemetry data management computing module 216 can (dynamically) adjust the time interval for subsequent telemetry data values of the characteristics to be obtained. The subsequent telemetry data values of the characteristic can be compared to associated telemetry data value ranges (as in 312) for a determination of whether they are outside of such ranges (as in 314), described above. In some examples, the telemetry data management computing module 216 adjusts the parameters associated with the port 210 including obtaining telemetry data values of one or more differing characteristics associated with the port 210. That is, the telemetry data management computing module 216 can obtain telemetry data values of one or more additional characteristics that differ from the characteristics that the telemetry data values were initially obtained for. That is, once the external computing device 204 is engaged with the port 210 and the initial telemetry data values are obtained, the telemetry data management computing module 216 can obtain telemetry data values of one or more additional characteristics that differ from the characteristics that telemetry data values were initially obtained for. The subsequent telemetry data values of the characteristic can be compared to associated telemetry data value ranges (as in 312) for a determination of whether they are outside of such ranges (as in 314), described above. For example, the additional characteristics can include characteristics related to the port 210 being HDMI, or DisplayPort (DP) over Thunderbolt.

The telemetry data management computing module 216 determines if there is a further characteristic to identify, at 318. If the telemetry data management computing module 216 determines that there is a further characteristic to identify, the process returns to step 310. If the telemetry data management computing module 216 determines that there is not a further characteristic to identify, the PD controller 212 and/or the EC 214 can determine whether the port 210 is still engaged with the external computing device 204, at 320 (similar to that as described at step 304). That is, the PD controller 212 and/or the EC 214 can determine whether or not the external computing device 204 has become disengaged from the port 210 after the telemetry data values of the characteristics of the port 210 have been obtained and analyzed.

If the PD controller 212 and/or the EC 214 determine that the port 210 is not engaged with the external computing device 204, the process returns to step 302.

If the PD controller 212 and/or the EC 214 determine that the port 210 is still engaged with the external computing device 204, the telemetry data management computing module 216 determines whether the time interval has lapsed, at 322. In some examples, the telemetry data management computing module 216 determines that the time interval has not lapsed, and returns to step 322. That is, the telemetry data management computing module 216 determines that not enough time has lapsed to re-obtain the telemetry data values (at 306). In some examples, the time interval can be 1 minute, 5 minutes, 10 minutes, and the like. In some examples, the telemetry data management computing module 216 determines that the time interval has lapsed, and returns to step 306.

In some examples, the telemetry data management computing module 216 determines that the telemetry data value for the particular characteristic is not outside of the telemetry data value operating range associated with the particular characteristic (at 314), and proceeds to step 318.

In some examples, the PD controller 212 and/or the EC 214 determine that the port 210 is not engaged with the external computing device 204 (at 304), and in response, places the port 210 in a dormant state, at 324. That is, the PD controller 212 and/or the EC 214 determine that the port 210 is disengaged from the external computing device 204. In response, the PD controller 212 and/or the EC 214 can place the port 210 in a dormant state such that obtaining of the telemetry data values is halted for a time period. That is, power can be halted to be provided (from the information handling system 202) at the port 210 for a time period. The time period can be 1 minute, 5 minutes, 10 minutes, and the like. After the time period, the method can proceed to step 302.

In a use case, the port 210 can be connected to multiple various adapters/docking stations (external computing device 204) at different times, each with different wattage levels and fluctuating connection frequencies. Telemetry data values can be obtained upon connection of the adapter/docking station with the port 210 to optimize power delivery at the port 210.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

1. A computer-implemented method of proactive management of ports of an information handling system, comprising:
determining whether a port of the information handling system is engaged with an external computing device, wherein the external computing device is a power adapter;
in response to determining that the port is engaged with the external computing device:
obtaining telemetry data values of one or more characteristics associated with the port;
analyzing the telemetry data values, including, for one or more of the characteristics:
comparing the telemetry data value for the particular characteristic to a telemetry data value operating range associated with the particular characteristic;
determining, based on the comparing, whether the telemetry data value for the particular characteristic is outside of the telemetry data value operating range associated with the particular characteristic; and
in response to determining that the telemetry data value for the particular characteristic is outside of the telemetry data value operating range associated with the particular characteristic, adjusting one or more parameters associated with the port.

2. The computer-implemented method of claim 1, further including storing the telemetry data values at a data store.

3. The computer-implemented method of claim 1, wherein determining that the port is engaged with the external computing device further includes determining that the external computing device is receiving power through the port.

4. The computer-implemented method of claim 1, wherein adjusting the one or more parameters associated with the port includes adjusting a time interval for obtaining the telemetry data values of the one or more characteristics associated with the port.

5. The computer-implemented method of claim 1, wherein adjusting the one or more parameters associated with the port includes obtaining telemetry data values of one or more differing characteristics associated with the port.

6. The computer-implemented method of claim 1, further including:
in response to determining that the port is not engaged with the external computing device, putting the port in a dormant state such that obtaining the telemetry data values is halted for a time period.

7. The computer-implemented method of claim 1, wherein the port is a Universal Serial Bus (USB) Type-C port.

8. (canceled)

9. An information handling system comprising a processor having access to memory media storing instructions executable by the processor to perform operations, comprising:
determining whether a port of the information handling system is engaged with an external computing device, wherein the external computing device is a power adapter;
in response to determining that the port is engaged with the external computing device:
obtaining telemetry data values of one or more characteristics associated with the port;
analyzing the telemetry data values, including, for one or more of the characteristics:
comparing the telemetry data value for the particular characteristic to a telemetry data value operating range associated with the particular characteristic;
determining, based on the comparing, whether the telemetry data value for the particular characteristic is outside of the telemetry data value operating range associated with the particular characteristic; and
in response to determining that the telemetry data value for the particular characteristic is outside of the telemetry data value operating range associated with the particular characteristic, adjusting one or more parameters associated with the port.

10. The information handling system of claim 9, the operations further including storing the telemetry data values at a data store.

11. The information handling system of claim 9, wherein determining that the port is engaged with the external computing device further includes determining that the external computing device is receiving power through the port.

12. The information handling system of claim 9, wherein adjusting the one or more parameters associated with the port includes adjusting a time interval for obtaining the telemetry data values of the one or more characteristics associated with the port.

13. The information handling system of claim 9, wherein adjusting the one or more parameters associated with the port includes obtaining telemetry data values of one or more differing characteristics associated with the port.

14. The information handling system of claim 9, the operations further including:
in response to determining that the port is not engaged with the external computing device, putting the port in a dormant state such that obtaining the telemetry data values is halted for a time period.

15. The information handling system of claim 9, wherein the port is a Universal Serial Bus (USB) Type-C port.

16. A non-transitory computer-readable medium storing software comprising instructions executable by one or more computers which, upon such execution, cause the one or more computers to perform operations comprising:
determining whether a port of the information handling system is engaged with an external computing device, wherein the external computing device is a power adapter;
in response to determining that the port is engaged with the external computing device:
obtaining telemetry data values of one or more characteristics associated with the port;
analyzing the telemetry data values, including, for one or more of the characteristics:
comparing the telemetry data value for the particular characteristic to a telemetry data value operating range associated with the particular characteristic;
determining, based on the comparing, whether the telemetry data value for the particular characteristic is outside of the telemetry data value operating range associated with the particular characteristic; and
in response to determining that the telemetry data value for the particular characteristic is outside of the telemetry data value operating range associated with the particular characteristic, adjusting one or more parameters associated with the port.

17. The non-transitory computer-readable medium of claim 16, the operations further including storing the telemetry data values at a data store.

18. The non-transitory computer-readable medium of claim 16, wherein determining that the port is engaged with the external computing device further includes determining that the external computing device is receiving power through the port.

19. The non-transitory computer-readable medium of claim 16, wherein adjusting the one or more parameters associated with the port includes adjusting a time interval for obtaining the telemetry data values of the one or more characteristics associated with the port.

20. The non-transitory computer-readable medium of claim 16, wherein adjusting the one or more parameters associated with the port includes obtaining telemetry data values of one or more differing characteristics associated with the port.
